(19) United States
(12) Patent Application Publication
(10) Pub. No.: US 2023/0313499 A1
(43) Pub. Date: Oct. 5, 2023

(54) SUPPORT AND GUIDING APPARATUS FOR FEEDER LINES FOR EXCAVATION DEVICES

(71) Applicant: SOILMEC S.P.A., Cesena (FC) (IT)

(72) Inventors: Paolo TIEZZI, Forlì (FC) (IT); Alberto PICCININI, Cesena (FC) (IT)

(73) Assignee: SOILMEC S.P.A., Cesena (FC) (IT)

(21) Appl. No.: 18/018,895

(22) PCT Filed: Jul. 23, 2021
(86) PCT No.: PCT/IB2021/056667

§ 371 Date: Jan. 31, 2023

(30) Foreign Application Priority Data
Jul. 31, 2020 (IT) 102020000018844

(51) Int. Cl. E02F 9/22; E02F 3/20

(52) U.S. Cl. CPC E02F 9/2275; E02F 3/205

(57) ABSTRACT

A support and guiding apparatus for feeder lines includes a feeding tube for a digging device, a support branch, and a plurality of crosspieces adapted for guiding the feeding tube and connected to the support branch. The support branch includes a single flexible traction element and a plurality of spacer elements coupled to the single flexible traction element. The flexible traction element defines a longitudinal axis X when the flexible traction element is in an extended configuration. The flexible traction element has a cross section S having a width B greater than a height H. Each one of the spacer elements has a first seat housing the flexible traction element and which is crossed by the flexible traction element. The first seat is shaped to prevent rotation of the spacer element. Each one of the spacer elements is arranged to allow rotation of the support branch.

The present invention relates to a support and guiding apparatus for feeder lines, e.g. comprising hydraulic oil circuits and/or electrical instrumentation, if any, for a digging device or tool, e.g. a hydro-mill or hydraulic bucket, to be preferably mounted on a crane, cable excavators or drilling machine, for making diaphragms in the ground.

It is known that, in the field of drilling in the ground, in particular that of diaphragms, digging devices moved by means of a rope lifting device are usually used. These digging devices carry out excavations with a substantially rectangular cross section in the ground, down up to depths of a few hundred meters. Then, once the digging tool has been removed, the excavations are filled with hardening material, such as cement, and possibly with reinforcing elements, such as metal cages, in order to obtain panels or diaphragms in the ground. These panels can have either structural functions as foundation elements or waterproofing functions. During the excavation, the excavation itself is kept filled with stabilising fluid which, thanks to the pressure generated, has the function of supporting the walls of the section already excavated and preventing them from collapsing. The stabilising fluids or slurries are generally mixtures containing bentonite or polymers. The digging device, also known as the digging module, is then immersed in the stabilising fluid while the excavation is being carried out.

In the event that the digging tool is a hydro-mill, normally used to create diaphragms, in order to be able to supply drive power to this digging tool, it is necessary to connect the latter to a series of feeder lines, comprising tubes and/or cables such as hydraulic oil tubes, cables for the electrical instrumentation and the control, which are generally also inserted inside feeding tubes provided with constructional expedients in order to be compatible with the work site, in particular to be suitable for being immersed in the stabilising fluid during excavation. These feeder lines therefore connect the digging module to the base machine located on the ground level, on which hydraulic and electrical power generation devices are installed, such as hydraulic pumps, endothermic motors, electric motors and batteries. The base machine can be, for example, a crawler crane, a rope excavator or a drilling machine. The feeder lines, starting from the digging tool, are usually operated on a drum pulley placed at the top of the arm from which said tool is suspended and then descend towards the base machine on which they are collected and accumulated. The feeder lines must follow the descent or ascent movement of the digging device inside the excavation, thus being immersed in the stabilising fluid. To ensure that the feeder lines are kept in an orderly position during the movement of the digging tool, these feeder lines are wound onto a rotating drum of a winder, usually installed on the base machine, which, by rotating, retrieves or unwinds them according to the necessary movements required by the excavation. The feeder lines are then deposited on the drum of the winder, being accumulated in several overlapping layers or turns, so that each new outer layer is wound with a greater radius of curvature than those already wound which are closer to the rotation axis of the drum. Because of their weight, when the feeding tubes of the lines are wound around the winch drum, each turn is subjected to strong pressures that are generated by the weight of all the successive outermost turns superimposed thereon. This means that the innermost turn, the one wound directly onto the drum, is subject to the greatest pressures. When the depths of the excavation are large, more than 100 m, the length and the weight of the feeder lines are considerable, and this can create excessive loads and stresses on the lines themselves, both on the section unwound by the drum and suspended from the arm of the base machine, and on the section still wound on the winder drum.

It is necessary for the section of the feeder lines unwound from the drum that the lines are guided and supported, both to avoid tangling of the lines during their ascent and descent in the excavation, and to allow them to slide correctly on the drum of the pulley at the top of the support arm, and to prevent excessive pulling force, generated by their own weight, from creating excessive elongations of the tubes or cables, causing, in some cases, unwanted breakages. If the tubes or cables are too elastic, the movement system may not be able to respond promptly to the winding and unwinding commands from the winch drum, causing problems with the correct winding. It is therefore necessary to relieve the feeder lines of at least part of the effect of their weight by connecting them to support and guiding elements, which are structured to support the weights without causing deformations or elongations of the lines themselves. In fact, the mere increase in the thickness of the feeding tubes in order to increase the bearing capacity thereof would reduce their flexibility and this would not allow a sufficiently fast winding on the drum. It is therefore necessary to constrain the feeding tubes together so that they can be wound in an orderly manner, and to fix them to suitably structured support and guiding elements, so that in the section of the feeder lines that is wound on the drum, these support elements sustain the loads generated by the weight of the layers of wound tubes, relieving the tubes themselves of these loads, so that they do not suffer structural damage, such as crushing. In addition, the support and guiding elements must prevent tangling between the feeding tubes themselves during their movement.

It is known from European patent EP0518292, a digging device, e.g. a hydro-mill, in which the feeding tubes are kept at a distance from each other, in parallel, by transverse bars, also called crosspieces, which are fixed along the tubes at regular intervals; these bars are kept at the right distance from each other, in the longitudinal direction of the tubes, by suitable shaped spacers, creating two support branches that are arranged laterally to the tubes.

The ends of the transverse bars and the shaped spacers are crossed by a support rope for each branch. In particular, the spacers have a hole that allows the rope to pass through while leaving the spacers to slide axially with respect to the rope. The shaped spacers are interposed between two consecutive bars, during the assembly step of the feeder lines, in an adequate number for all the space present between the two bars to be filled, so as to keep these bars at the desired distance. During this assembly step, the support ropes are not subject to external loads.

When the feeder lines are extended inside the excavation, the full weight of the tubes and spacer elements rests on the two lateral support ropes. Due to the weight of the digging module and due to the tension generated when extracting the digging module from the fluid-filled excavation, elongation of the support ropes can occur. Due to the fact that the spacers and the transverse bars slide along these ropes, this elongation would mean that in the section between the tool and the return pulley, located in the upper area of the support arm, all the spacers and the transverse bars would tend to slide downwards leaving a section of the ropes near the pulley uncovered, i.e. a free section of rope would be created between the spacers and the rope could rest directly on the pulley surface. Since the excavation depths can be of the order of hundreds of meters, even small percentage elongations of the support ropes can create sections of free rope of considerable length between the spacers. These sections of free rope are not compatible with the correct sliding of the feeder lines on the return pulley, since, for example, during the ascent of the tool, the first spacers below the free section of rope would approach the pulley in a position that is not tangent thereto, and this could cause entanglements, jams and damage to the lines themselves, or even the impossibility of continuing the extraction manoeuvres of the tool from the excavation itself.

In fact, due to the elongation of the support ropes, the spacer elements are no longer guided and are no longer in contact with each other, and can rotate around the axis of the rope, being able to place themselves in anomalous positions. The rotation of the spacer elements can be caused by the vibrations that are always present during the excavation step, or by the simple movement of the drilling machine or the tool. Generally, the spacers have a greater width than their own thickness and it is wished that during a correct winding of the lines the lower faces of the spacer elements rest on the pulley or on the winder, in order to maintain the lowest contact pressure and keep the minimum thickness of each wound layer. As a result of the rotation of one or more spacers, these elements could rest on the pulley or on the winder with their side face instead of with the lower face. In this case, when the tubes are rewound, the spacers may get caught on the return pulley, preventing the tubes from being rewound. Similarly, a localised variation in the thickness of the branch wound on the rope may occur, due to one or more rotated spacer elements not being arranged according to their minimum thickness, and this leads to damage and problems when a subsequent layer of the feeder lines is deposited on this zone. Furthermore, as a result of the rotations, sections of free rope can be created between consecutive spacer elements, complicating, or even preventing, the operation of recovery of the tubes through the return pulley.

An apparatus adapted for guiding and supporting the weight of a set of tubes for feeder lines is known from U.S. Pat. No. 7,845,154, consisting of two lateral support branches, connected by transverse bars to the tubes, which are held at the desired distance by a series of spacer elements interposed between them. Each spacer element is crossed by at least one pair of ropes, and is axially sliding with respect to these ropes.

This patent aims to solve the problem of the rotation of the spacer elements when the rope is wound on the drum, or when the branch is suspended vertically along the excavation. To overcome this problem, a second rope with a smaller diameter is inserted in each branch in a suitable hollow housing in order to avoid rotation of the elements. This second rope, given its anti-rotation function only, is thinner and less rigid than the main rope as it does not bear any suspension or support load.

In this case, a further problem of alignment and spacing of the spacer elements arises, due to the fact that under the great weight of the tubes and all the hanging parts, the two ropes will absorb axial loads differently from each other in view of their different stiffness. In particular, the support rope will support the load, leaving the second rope of smaller diameter unloaded.

The maximum elongations, which the two ropes will undergo, will however only be associated with those of the support rope.

In the situation of elongation of the support ropes, the second rope of smaller diameter is unloaded and not sufficiently taut, leaving the possibility for the spacer elements to rotate around the hole corresponding to the axis of the support rope.

The object of the present invention is to overcome the above-mentioned drawbacks and, in particular, to devise a support and guiding apparatus for feeder lines which ensures an easy winding on a winder drum.

This and other purposes according to the present invention are achieved by making a support and guiding apparatus for feeder lines as set out in claim 1.

Further features of the support and guiding apparatus for feeder lines are the subject of dependent claims.

The characteristics and advantages of a support and guiding apparatus for feeder lines according to the present invention will become more evident from the following illustrative and non-limiting description, referring to the appended schematic drawings in which:

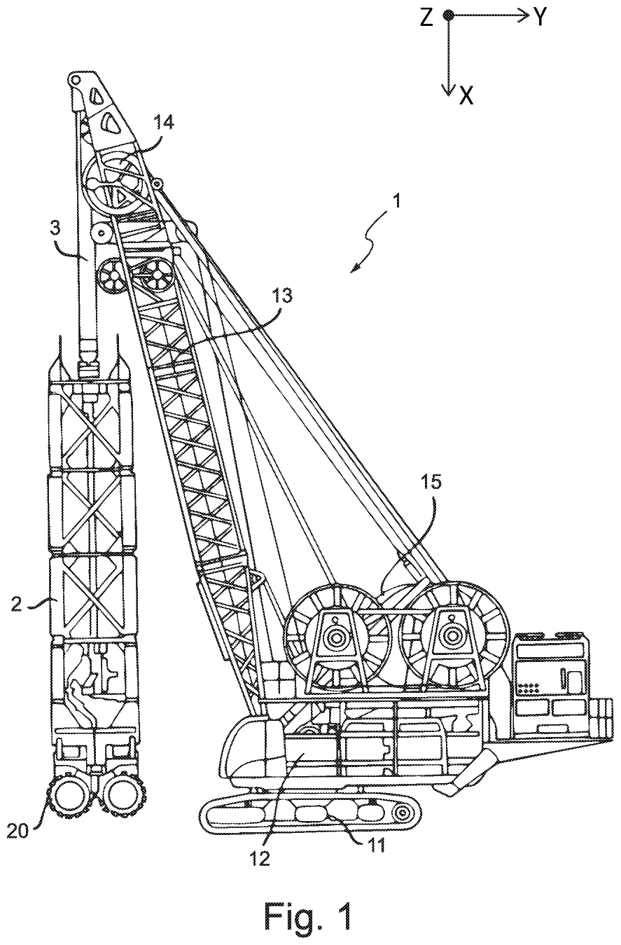

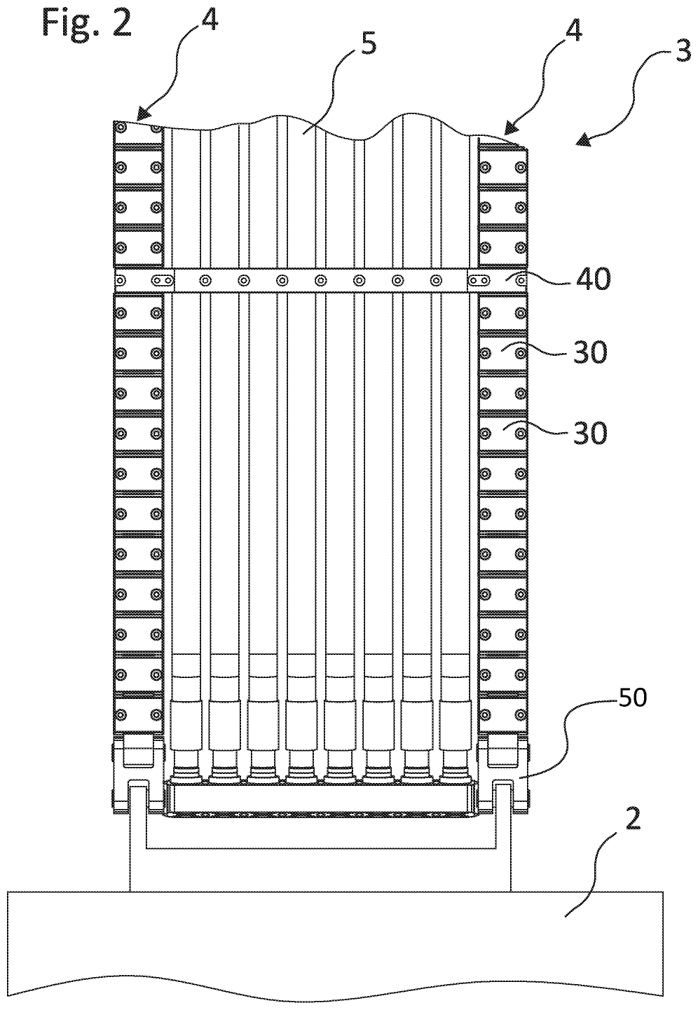

FIG. 1 is a schematic assembly view illustrating a drilling machine for diaphragms, with digging tool provided with cutting wheels, on which a feeder line is installed, comprising the support and guiding apparatus of the feeder line, according to the present invention;

FIG. 2 is a partial frontal schematic view of the support and guiding apparatus for feeder lines according to the present invention;

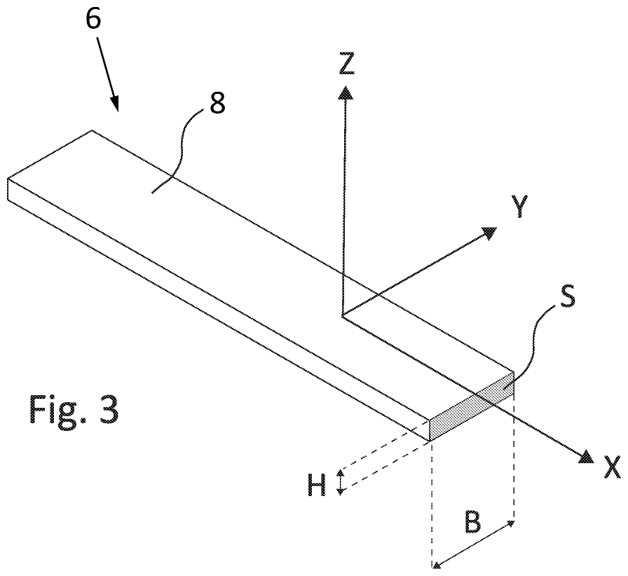

FIG. 3 is a perspective view of a section of a flexible traction element included in the apparatus of FIG. 2;

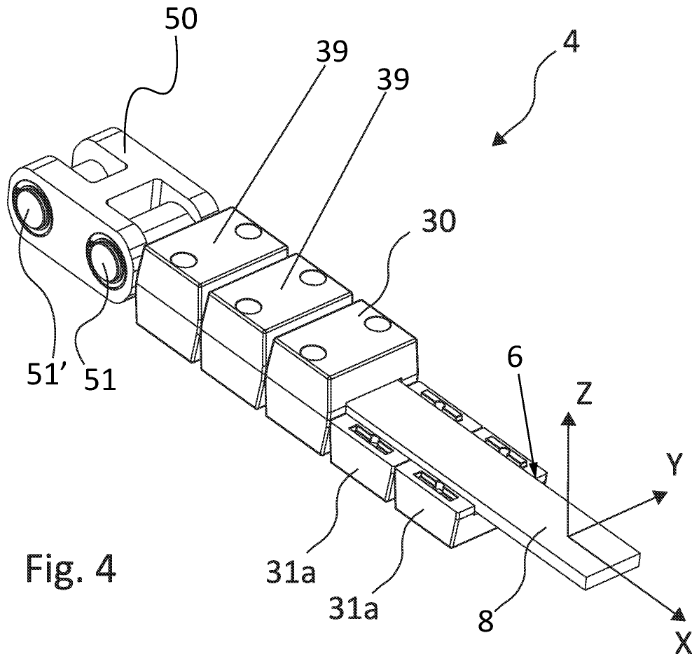

FIG. 4 is a perspective view of a portion of a support branch included in the apparatus of FIG. 2;

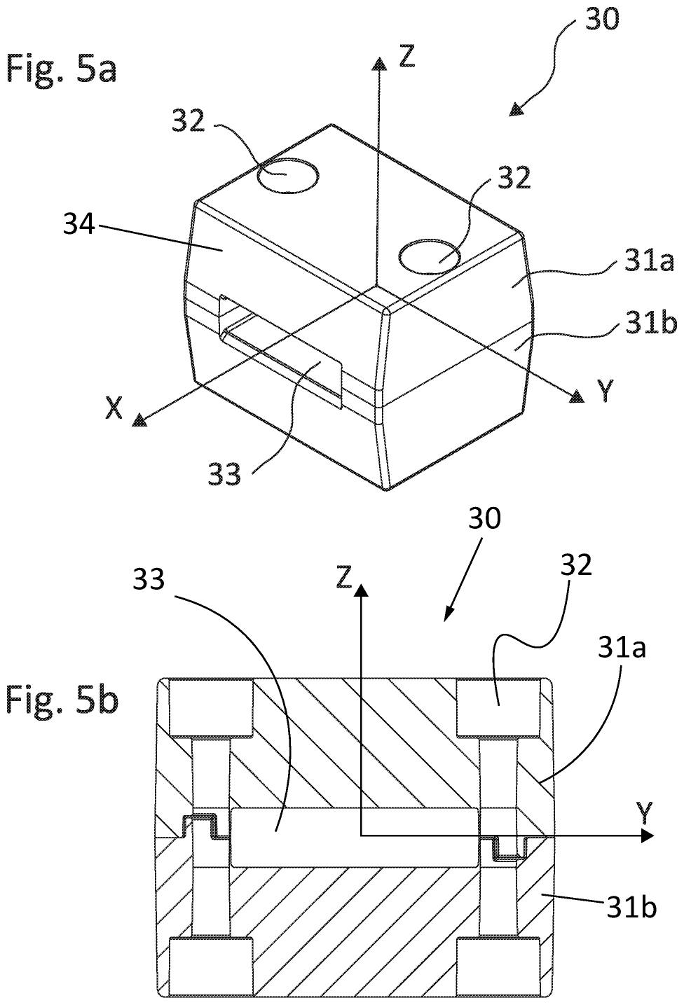

FIGS. 5A and 5B are two schematic views, respectively perspective and cross sectional, of an assembled spacer element included in the support branch of FIG. 4;

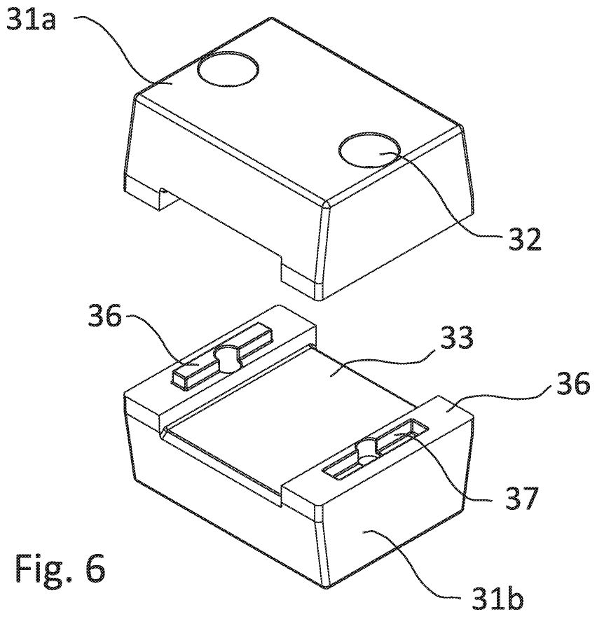

FIG. 6 is an exploded perspective schematic view of the spacer element in FIGS. 5a and 5b;

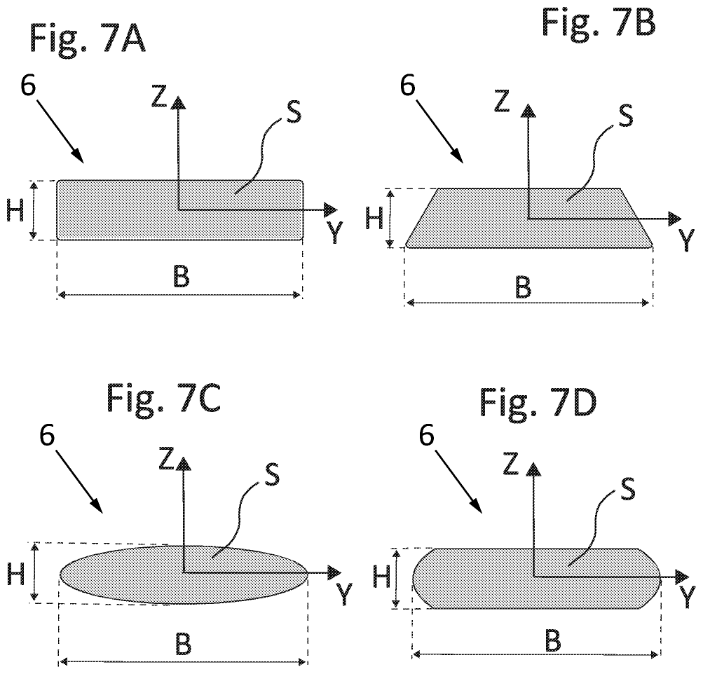

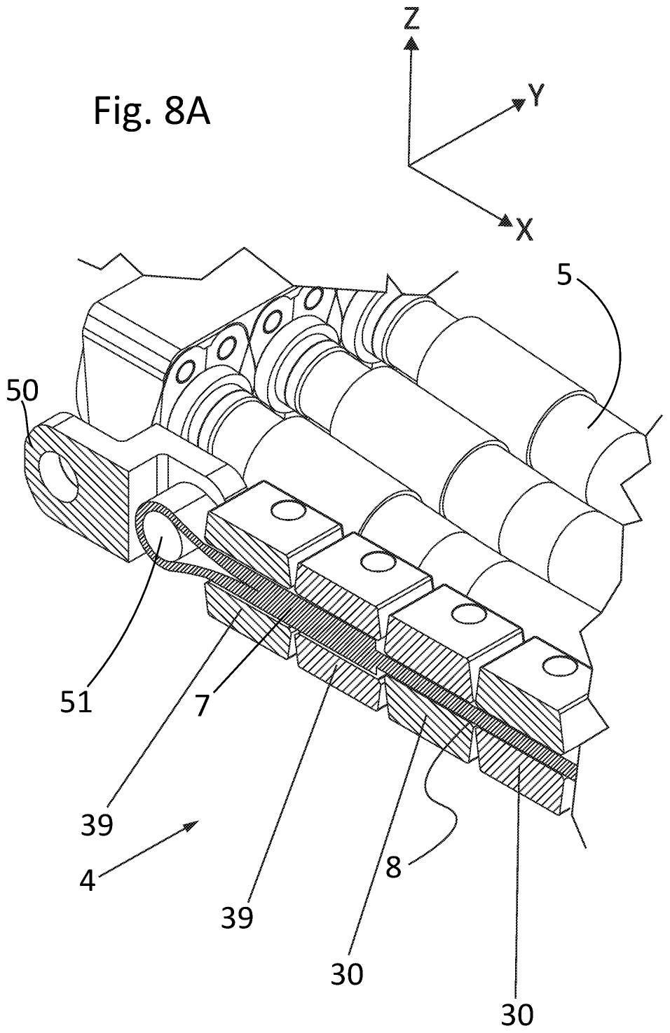

FIGS. 7A, 7B, 7C, 7D show different possible embodiments of the section of the flexible traction element included in the apparatus of FIG. 2;

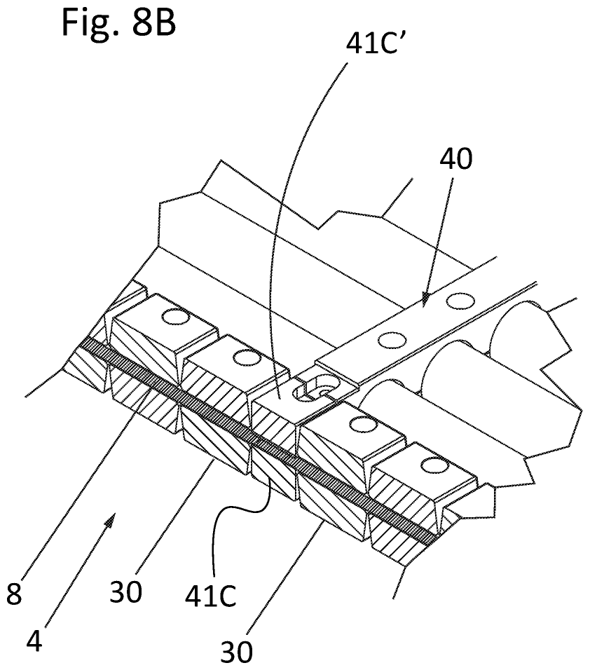

FIGS. 8a and 8b are two perspective and partially sectioned views of two different sections of a support branch included in the apparatus of FIG. 2;

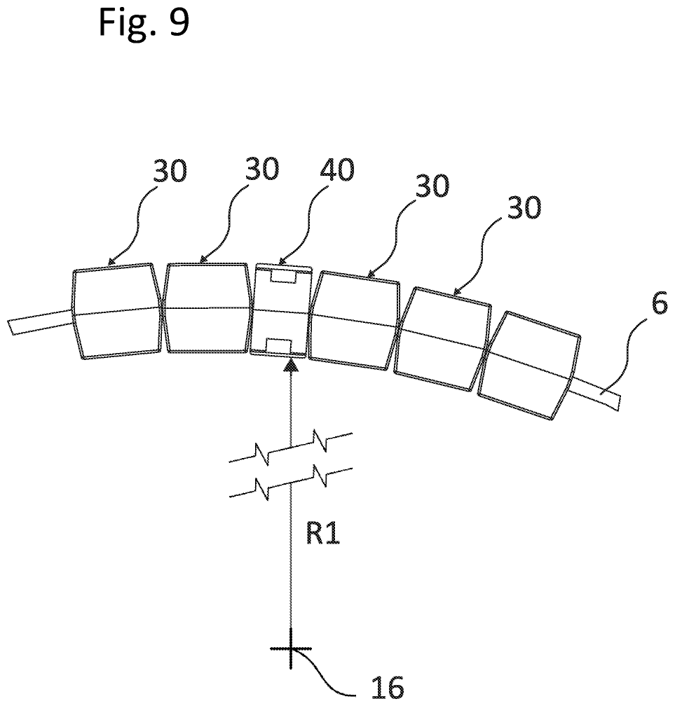

FIG. 9 is a schematic side view of a support branch section wound with a radius of curvature R1 on a winder;

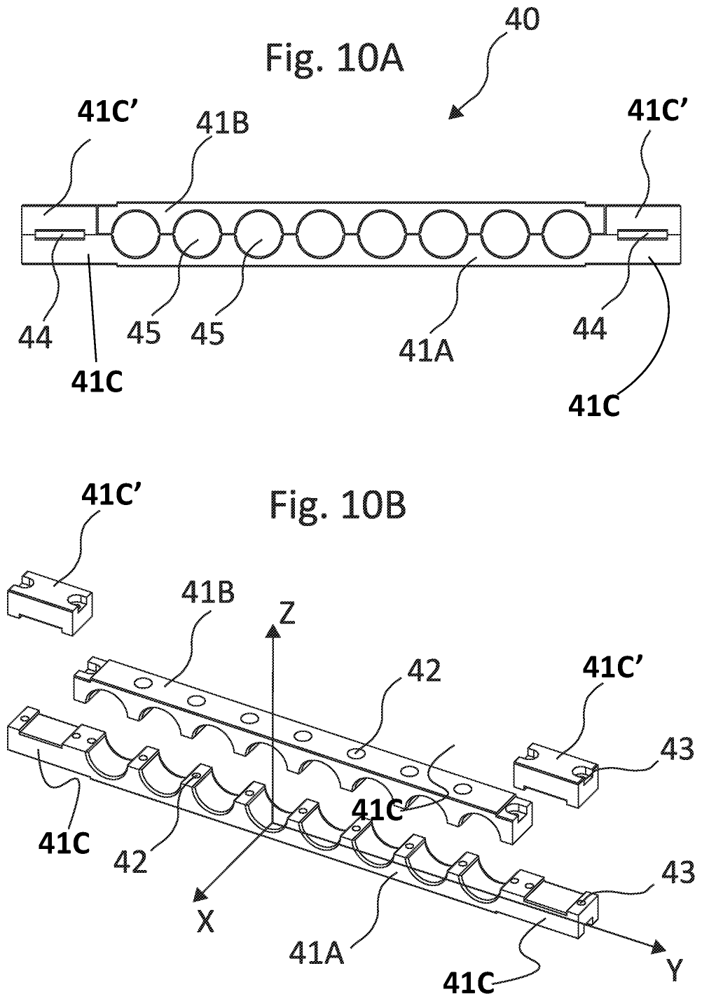

FIG. 10A is a frontal schematic view of a crosspiece of the apparatus of FIG. 2 in an assembled configuration;

FIG. 10B is a schematic perspective view of a crosspiece of the apparatus of FIG. 2 in an unassembled configuration.

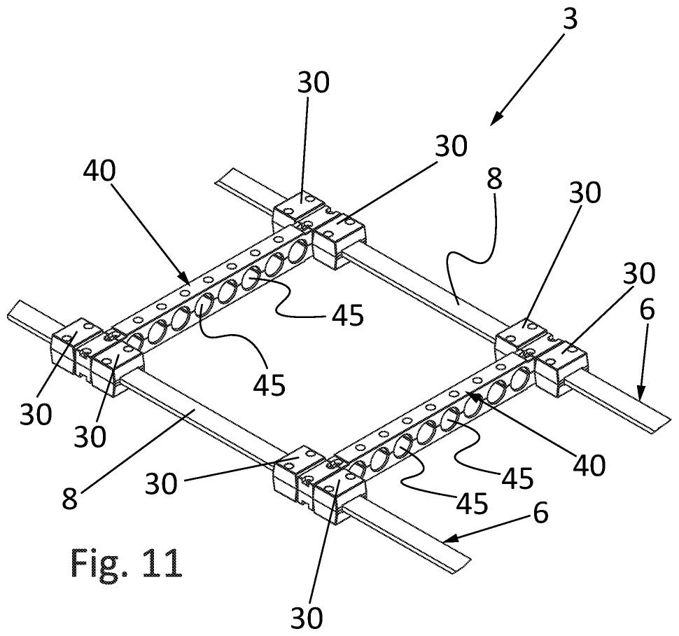

FIG. 11 is a schematic perspective view of a partial of the support and guiding apparatus for the feeder lines according to the present invention partially assembled.

With reference to the figures, a support and guiding apparatus 3 for feeder lines of a digging device 2 of a drilling machine 1, preferably for making diaphragms, is shown. The digging device can be provided with any cutting and/or digging tool, although in the figures it is shown provided with cutting tools 20 such as milling wheels.

The drilling machine 1, also known as the base machine, is for example a rope excavator or crane, or a crawler drilling machine with vertical tower.

FIG. 1 shows a drilling machine 1 which comprises an undercarriage 11 surmounted by a rotating turret 12 associated with a tilting arm 13. In the remainder of the present discussion, for simplicity's sake, reference will be made to a drilling machine with a tilting arm such as that shown in FIG. 1, although the invention may be applied to a drilling machine with vertical tower, or a machine in which the tilting arm 13 may be with a box-like beam structure.

As is visible in FIG. 1, a return pulley 14 is preferably mounted on the arm 13 for the support and guiding apparatus for feeder lines. This pulley may also be a cylinder or drum and have a width comparable to that of the guide and supporting apparatus 3, to allow this apparatus to rest across its full width. The feeder lines comprise feeding tubes 5 which may therefore be tubes in which hydraulic hoses and/or electrical cables for signal and/or power transmission run, or they may themselves be hydraulic hoses.

The support and guiding apparatus 3 for feeder lines is arranged to connect the drilling machine 1 and the digging device 2, and is moved by a winder 15, preferably motorised in order to actuate the rotation thereof, installed on board the rotating turret 12. In an alternative embodiment, the winder 15 may not be installed directly on the drilling machine 1 but may be fixed to a further means which is arranged with respect to the machine in such a manner the feeding tubes 5 and the entire support and guiding apparatus can move and wind up smoothly. In any case, the support and guiding apparatus 3 for feeder lines is arranged to be wound around a winding axis.

The feeding tubes 5 are connected at one end to the digging device 2 by means of a manifold with flanges and at a second end with the winder 15 by means of a further manifold with flanges.

As shown in FIG. 2, the support and guiding apparatus 3 for feeder lines comprises at least one support branch 4 and a plurality of transverse connecting elements or crosspieces 40, adapted for guiding the feeder lines 5, connected to the at least one support branch 4. The at least one support branch 4 is connected at a first end with the digging device 2 by means of first fixing means 50, 51, 51′, which engage on appropriate attachments that are present on the digging device 2; the at least one support branch 4 is then connected at a second end with the winder 15 by means of second fixing means (not shown), which may be identical to the first fixing means 50, 51, 51′ and which engage on appropriate attachments that are present on the winder 15.

A section of this support branch 4 is shown in FIG. 4 in a straight configuration, i.e. in the condition in which it is arranged when a load is applied in the longitudinal direction of the support branch 4, i.e. along the axis X according to the Cartesian triad shown in FIG. 4. This load may also be represented by the own weight of the support branch 4. Each support branch 4 comprises at least one flexible traction element 6, coupled with a plurality of spacer elements 30, 39 arranged in succession to each other along the flexible traction element 6.

In one embodiment of the present invention, the support and guiding apparatus 3 for feeder lines comprises a single support branch 4 associated with a flexible traction element 6 mounted at an intermediate, preferably central, position of the feeder line, i.e. with the feeding tubes 5 being arranged substantially parallel on either side of the support branch 4. This embodiment with a single support branch 4 is particularly adapted for configurations intended for shallow excavations.

Two or more support branches 4 may be provided for deep excavations. In the embodiment illustrated in FIG. 2, for example, the guiding and support apparatus 3 for feeder lines has two support branches 4 mounted at the two lateral ends of the feeder line, i.e. with the feeding tubes 5 being all arranged between the two support branches 4.

As is visible in FIG. 3, when the flexible traction element 6 is subjected to traction, it tends to arrange itself in a straight or extended configuration along the longitudinal axis X.

The flexible traction element 6 has two longitudinally opposed end sections 7 and an intermediate section 8 interposed between these end sections 7. The length of these end sections 7 of a few tens of centimetres is much less than the total length of the flexible traction element 6 which can be several tens of metres. By sectioning, at least the intermediate section 8 of the flexible traction element 6 in a plane perpendicular with respect to this longitudinal axis X, it is possible to identify the so-called “cross section S” thereof which will then develop on the plane Y-Z as shown in FIG. 3. This cross section S will therefore have two maximum dimensions or “overall dimension” in the two directions Y and Z which are indicated in FIG. 3 by the letters B and H, respectively. The dimension B, which extends in the direction Y, is called the “cross section width” and is equal to the width of the traction element 6 at least in the intermediate section 8. The dimension H, extending in the direction Z, is called the “height or thickness of the cross section” and is equal to the thickness of the traction element 6 at least in the intermediate section 8.

The flexible traction element 6 according to the present invention has, at least in the intermediate section 8, a cross section S having a width B and a height or thickness H, wherein the width B is greater than the height or thickness H. The cross section S′ of the end sections 7 of the flexible traction element 6 may be equal to or different from the cross section S.

Preferably, the width B of the cross section S is at least 3 times greater than the height or thickness H of the cross section.

More preferably the width B of the cross section S is at least 4 times greater than the height or thickness H of the cross section.

The cross section S is “non-axisymmetrical” with respect to the longitudinal axis X and has an elongated shape along the direction Y like in the example in FIG. 3.

The fact that the cross section S has two very different dimensions in the directions Y and Z, it means that this cross section S has a moment of inertia about the axis Y which is very different from the moment of inertia about the axis Z. Consequently, the flexible traction element 6 when subjected to bending moments acting about the axis Y and the axis Z has, at least in the intermediate section 8, two very different resistances and two very different deformabilities with respect to the axis Y and the axis Z. With reference to FIG. 3, the flexible traction element 6 exhibits, at least in the intermediate section 8, greater deformability around the axis Y and less deformability around the axis Z. Thus, if a torque or bending moment is applied to the flexible traction element 6 about the axis Y, the element can easily deform by bending around the axis Y, and thereby the possibility of being able to wind the flexible traction element 6, and consequently the support branch 4, on a drum with an axis parallel to the axis Y is favoured. If, on the other hand, a torque or bending moment is applied to the flexible traction element 6 around the axis Z, the element will hardly deform by bending around the axis Z, which reduces possible lateral deformations by ensuring a good alignment along the axis X of the flexible traction element 6 and the support branch 4 during use of the support and guiding apparatus 3 under operating conditions. Furthermore, the fact that the cross section S has a greater extension in one direction than the other, i.e. whose shape is elongated and not axisymmetrical, it favours, with the same cross section, a greater torsional resistance around the axis X. Thus, if the cross section S is compared to a circular cross section with same area, these cross sections would have equal tensile strength if they were subjected to a force along the longitudinal axis X, but would have very different deformability if they were subjected to a torsional torque around the axis X. In fact, the fact that the cross section S has an elongated shape in the direction Y transverse to the axis X means that there is more resistant material away from the axis X, again compared to a circular cross section, and this ensures less torsional deformability around the axis X. For this reason, the flexible traction element 6 can hardly deform by twisting or wrapping around the axis Z, and this reduces possible torsions of the support branch 4 during use of the support and guiding apparatus 3 under operating conditions.

According to further possible embodiments of the invention, the shape of the cross section S of at least the intermediate section 8 of the flexible traction element 6 may be selected from a variety of permissible shapes, some of which are shown in FIGS. 7A-7D by way of example. In FIG. 7A, the cross section S, carried out in a plane Y-Z, has a rectangular shape which is totally similar to that already described for FIG. 3 and may possibly have bevelled or rounded edges. In FIG. 7B, the cross section S, carried out in a plane Y-Z, has a trapezoid shape, with width B equal to the largest base of the trapezoid and thickness H equal to the height of the trapezoid. Also in the case of FIG. 7B the width B is at least 3 times greater than the height or thickness H. In FIG. 7C the cross section S, carried out on a plane Y-Z, has an elliptical shape, with width B equal to the larger axis of the ellipse and height or thickness H equal to the smaller axis of the ellipse. Also in the case of FIG. 7C, carried out in a plane Y-Z, the width B is at least 3 times greater than the height or thickness H. In FIG. 7D the cross section S has a compound shape, formed by a rectangular central section and two semi-circular ends. The width B of the cross section is equal to the maximum overall dimension of the section along the Y axis, whereas the height or thickness H is the maximum overall dimension of the section along the axis Z, equal to the height of the rectangular section in this case. Also in the case of FIG. 7D the width B is at least 3 times greater than the height or thickness H. So, FIGS. 7A-7D show only some examples of possible shapes of the section but it would be possible to use many others that respect the constraint of having two dimensions one dimension of which, the width, is greater than the other, the height or thickness.

According to the present invention, the cross section S is constant, i.e. it does not undergo changes in shape or size, along the length of at least the intermediate section 8 of the flexible traction element 6 along the longitudinal axis X. In the end sections 7, the height i.e. the thickness of the cross section S′ may vary due to the need to make connecting ends of the flexible traction element 6. These end sections 7 will be better described later with reference to FIG. 8a.

According to the present invention, the term flexible is intended to indicate the property of the traction element 6 that it can be deformed with respect to the extended straight condition already shown in FIG. 3, in order to assume a flexed or curved condition and can maintain this deformed condition without the need for an external force to be maintained applied and without undergoing plastic or elastic deformations. In particular, it is intended to indicate the property of the flexible traction element 6 that it is curved about an axis perpendicular with respect to the longitudinal axis X with a given radius of curvature, so as to be adapted for being wound and unwound on a winder or drum of a suitable radius.

The flexible traction element 6 is adapted for withstanding high longitudinal traction forces, i.e. pairs of forces with opposite direction along the axis X, each of which is applied to one end of the flexible traction element 6. In particular, the traction element 6 can withstand large longitudinal tensile forces undergoing only minimal or no elongations in the longitudinal direction X. In contrast, the flexible traction element 6 is not adapted for withstanding longitudinal compressive loads, precisely because of its flexibility characteristic.

Preferably, the flexible traction element 6 is made up of fabric, i.e. it is made as a manufactured article constituted by a set of yarns woven together by weaving in a certain order so as to form a weft. This fabric is preferably constituted of synthetic or plastic yarns, such as polyamide, nylon or Kevlar aramid fibre. The characteristic of these synthetic materials is to have a great mechanical resistance but a low weight. This implies that if compared to steel, a flexible traction element 6 constituted of a fabric of such synthetic fibres can provide the same tensile strength as one made of steel, but having a much lower weight.

In an embodiment variant of the present invention, the fabric of which the flexible traction element 6 is constituted is at least partially or entirely made of metallic yarns. If the fabric is at least partially made of metallic yarns, it is made from metallic and synthetic yarns woven together.

Flexible traction elements, having a rectangular cross section like the one visible in FIG. 3, and made up of fabric can be called “lifting straps” or “lifting slings” or “lifting belts”. Such fabric flexible traction elements 6 may have two slots at the ends, which are made by folding the flexible traction element 6 on itself and sewing it, thus forming a termination loop. The end section 7 thus created has a height or thickness twice as high as the remaining extension of the flexible traction element 6.

The slots or termination loops allow the flexible traction element 6 and the support branch 4 to be fixed to other elements, such as to the digging device 2 or to the winder, by means of pins or other fixing means 50, 51, 51′. These fixing means 50, 51, 51′ can be, for example, single fork or double fork attachments (H shape). In the embodiment shown in FIG. 4, the fixing means 50, 51, 51′ comprise a double fork attachment 50, provided with appropriate holes to accommodate and constrain two pins 51, 51′, one in each fork. In this way, by means of a first pin 51 the termination loop of the flexible traction element 6 can be constrained to the double-fork coupling 50, and by means of a second pin 51′ the double-fork attachment 50 can be constrained to the digging device 2. In a simplified solution, the termination loop of the flexible traction element 6 could be fixed directly to the digging device 2 by means of a single connecting pin. In another embodiment variant, the fixing means 50, 51, 51′ could be of the “clamp” type in order to grip the end sections 7 and connect thereto by friction.

Each spacer element 30, 39 presents, when assembled, a shape substantially referable to a parallelepiped as illustrated in FIG. 5A.

For simplicity of discussion, considering a Cartesian reference system XYZ as shown by way of example in FIG. 5A, the footprint in the direction X is defined as the longitudinal dimension of the spacer element 30, 39, the footprint in the direction Y as the transverse dimension or width of the spacer element 30, 39 and the footprint in the direction Z as the height or thickness of the spacer element 30, 39.

The spacer elements 30, 39 can be coupled in an axially fixed or slidable way with respect to the flexible traction element 6.

In one embodiment of the present invention, the spacer elements 30, 39 are slidably coupled to the flexible traction element 6 in such a way that they are aligned and separated from each other by small clearances, when the guiding and support apparatus for feeder lines 3 is in an extended configuration, that is, when the support branches 4 are in a straight configuration. In this way, the spacer elements 30, 39 can perform small sliding movements with respect to the flexible traction element 6 since the sliding movements of the spacer elements 30, 39 are limited to recover the clearances that are present between one spacer element 30, 39 and the other. Each spacer element 30, 39 has a first seat or recess 33 adapted for housing and being crossed by the flexible traction element 6.

The first seat 33 is shaped in such a way as to orient the flexible traction element 6 along a lying plane XY, and to prevent rotation of the respective spacer element 30, 39 around the longitudinal axis X. Each one of the spacer elements 30, 39 is arranged to allow rotation of the support branch 4 around a rotation axis parallel to the axis Y.

In particular, the first seat 33 is made as a through cavity extending longitudinally between two opposite faces 34 of the spacer element 30, 39 perpendicular with respect to the longitudinal axis X of the spacer element 30, 39 and defining on each of said faces an opening having an elongated shape. The opposite faces 34 where the first seat 33 faces have an outside convex shape, that is, a substantially rounded outwardly profile.

The first seat 33 has a section of constant shape and size throughout its length. In particular, the shape of the cross section of the first seat 33, made in the plane Y-Z, has a shape adapted to couple with the shape of the cross section of the flexible traction element 6. The section of the first seat 33 therefore preferably has a shape complementary to that of the cross section of the flexible traction element 6, but dimensions in the plane YZ just slightly larger than the corresponding dimensions of the flexible traction element 6 in order to leave minimum clearances to allow a mutual longitudinal sliding between the spacer element 30, 39 and the traction element 6. The contour of the first seat 33 that is complementary to that of the cross section of the flexible traction element 6 also allows to prevent or at least limit the deformations of the cross section of the flexible traction element 6. In the case of flexible traction element 6 with a cross section S having a rectangular shape at least in the intermediate section 8 for example, the shape of the first seat 33 of the spacer elements 30 coupled to at least the intermediate section 8 is also rectangular and serves to keep the flexible traction element 6 substantially flat, preventing it from twisting by taking on curvatures.

If the cross section S′ of the end sections 7 is identical to the cross section S, the spacer elements 30 of the guiding and support apparatus 3 are identical to each other and have a first seat 33 with a cross section having a shape complementary to the cross section S.

An exemplary case where the cross section S′ of the end sections 7 is different from the cross section S is shown in FIG. 8A which is a perspective and partial view of the apparatus of FIG. 2, in which the support branch 4 is shown sectioned on the plane XZ. It can be seen that the increased thickness end section 7 of the flexible traction element 6 is coupled to spacer elements 39 having a first seat 33 with an increased height section. More generally, in the case where the cross section S′ of the end sections 7 is different from the cross section S the spacer elements 39 coupled to these end sections 7 have a first seat 33 having a cross section of a shape and dimension different from the first seat of the spacer elements 30 coupled to the intermediate section 8.

FIGS. 5a and 5b show an embodiment of the spacer element 30 in which the first seat 33 has a rectangular cross section adapted for coupling to the flexible traction element 6 shown in FIG. 3, also having a cross section S rectangular in shape, to form a support branch 4 such as the one shown partially in FIG. 4. When the spacer element 30 is applied to the flexible traction element 6, a form coupling is made between the first seat 33 and the flexible traction element 6 that prevents the mutual rotation between the spacer 30 and the flexible traction element 6 around the longitudinal axis X of the traction element. This effect of preventing the rotation around the axis X is due to the non-axisymmetrical shape of the cross section S of the flexible traction element 6 and the cross section of the first seat 33.

In a preferred embodiment visible in FIGS. 5a-5b and FIG. 6, the spacer element 30, 39 comprises a first half-shell 31A and a second half-shell 31B suitable, in the assembly, to be placed one above the other and constrained between them by means of fixing screws or bolts in first fixing through seats 32 made at corresponding positions on both half-shells 31A and 31B.

Each of the two half-shells 31A, 31B comprises a half-seat; when the two half-shells 31A, 31B are coupled together the two half-shells make the first seat 33.

As visible from FIG. 5B, which shows a section of the spacer element 30 carried out on a plane Y-Z passing through the two axes of the first fixing through seats 32, such first fixing through seats 32 may have sections with varying diameters along the thickness of the spacer element 30 in order to allow in the different sections the housing of the screw shanks, of the screw head or of the nut.

Preferably, the first fixing through seats 32 are further shaped in such a way that the screws and the other fixing components do not protrude from the thickness of the half-shells 31A and 31B when coupled. In addition, the diameter of the first fixing seats 32 may be large enough to allow the insertion of socket spanners to hold in rotation or to impart tightening torques to the elements of the bolts.

The two half-shells 31A and 31B have two abutment portions 36, lying on the plane XY, which come into contact with each other when the spacer element 30 is assembled. The abutment portions 36 bear the compressive load generated by the fixing screws of the half-shells 31A and 31B and extend along the longitudinal direction laterally to the first seat 33. Relief portions 38 and receiving portions 37 intended, during assembly, to engage each other, are formed on these abutment portions 36 at the through fixing seats 32. Said receiving portions 37 and relief portions 38 have the function of centring and abutting the two half-shells 31A and 31B ensuring the alignment of the respective fixing seats 32 in order to facilitate the insertion of the bolts into the seats and avoiding relative longitudinal sliding along the axis X of the two half-shells thus preventing the screws from exerting a shear.

In the alternative embodiment in which the spacer elements 30, 39 are axially fixedly engaged with respect to the flexible traction element 6 the dimensions in the plane YZ of the first seat 33 are just slightly smaller than the same dimensions of the flexible traction element 6 so that when the two half-shells 31A and 31B are constrained to each other they grip the flexible traction element 6 at the first seat 33.

In a further possible simplified embodiment, the spacer elements 30 are monolithic, i.e. made from a single shell rather than two modular half-shells. In this case, the spacer elements 30 have an external shape and overall dimensions equal to the version shown in FIG. 5A, and will have a first seat 33 equal to that of FIG. 5A. On the other hand, the first fixing through seats 32, the abutment portions 36, the receiving portions 37 and the relief portions 38 are not present as they are not necessary. In this embodiment, the spacer elements 30, 39 are installed on the support branch 4 by passing the flexible traction element 6 through the first seat 33, inserting it from the opening on one face 34 and exiting it from the opening on the opposite face 34. In this case it is necessary that the end sections 7 of the flexible traction element also have the same thickness as the intermediate section 8, at least during the assembly step of the spacer elements 30.

As shown in FIG. 9, a support branch 4 may be wound with a suitable radius of curvature R1 onto a drum of a winder 15, rotating about an axis 16. It is pointed out that in this Figure, for reasons of space, the centre of curvature of the drum 15, coinciding with the rotation axis 16, is not drawn in its actual position. The convex shape of the opposite faces 34 of the spacer elements 30 that are crossed by the first seat 33 and the small longitudinal clearances present between each spacer element 30 and the adjacent one, therefore allow for a corresponding rotation of each spacer element 30 with respect to the adjacent spacers around an axis perpendicular with respect to the longitudinal axis X of the flexible traction element 6.

The spacer elements 30, 39 can thus be arranged with their lower faces arranged tangent to the circumference of the drum of the winder 15, allowing the support branch 4 and the flexible traction element 6 to adapt to the curvature of the winder drum 15. A smaller radius of curvature corresponds to a greater reciprocal inclination of the adjacent spacers 30.

As can be observed in FIG. 9, the surfaces of the spacer elements 30, 39 intended to rest on the drum 15 or on already wound turns of the support branches 4 define a substantially continuous envelope surface.

As visible in FIGS. 10A and 10B, the crosspieces 40 are adapted for supporting the feeding tubes 5 and are connected to the at least one support branch 4 by extending in a transverse direction or in a direction perpendicular with respect to the longitudinal axis of the support branch 4. Each crosspiece 40 comprises at least one through guide seat 45, preferably cylindrical in shape, adapted to guide the feeding tubes 5. The through guide seats 45 are preferably equidistant from each other so as to create an orderly array of feeding tubes 5 that are also substantially equidistant from each other. More generally, the through guide seats 45 can be placed at any distance from each other.

Each crosspiece 40 comprises at least one through engagement seat 44, suitable to fix the crosspieces 40 to the flexible traction element 6.

Advantageously, the crosspieces 40, similar to the already described spacer elements 30, can be broken down into several parts and comprise a first half-crosspiece 41A and a second half-crosspiece 41B. The first half-crosspiece 41A and the second half-crosspiece 41B are provided at opposite ends along the direction Y of the support branch 4 respectively with first 41C and second 41C′ engagement portions that are arranged to engage with the flexible traction element 6. The engagement portions 41C, 41C′ can be made in one piece with the half-crosspieces 41A and 41B or as separate elements. In the embodiment illustrated in FIG. 10B, the first engagement portions 41C of the first half-crosspiece 41A are made as a single piece with said first half-crosspiece 41A, while the second engagement portions 41C′ are made as separate elements with respect to the second half-crosspiece 41B and can be coupled to the first engagement portions 41C of the first half-crosspiece 41A by means of fixing means.

The first half-crosspiece 41A and the second half-crosspiece 41B can be coupled to each other by means of connecting screws in corresponding second fixing slots 42. The first engagement portions 41C and the second engagement portions 41C′ may be coupled together by means of connecting screws in corresponding third fixing seats 43.

Advantageously, the through engagement seats 44 are made in the first 41C and the second 41C′ engagement portions. In particular, the through engagement seats 44 are formed by juxtaposition of two through fixing half-seats made in the first 41C and in the second 41C′ engagement portions.

The through guide seats 45 are preferably made in the form of clamps in order to be able to grip the feeding tubes 5 and thus to make the tubes themselves 5 integral with the crosspieces 40.

Preferably, the through engagement seats 44 are also made in the form of clamps in order to be able to grip the flexible traction elements 6 and thus to make the flexible traction elements 6 integral with the crosspieces 40. The through engagement seats 44 have a section with the same shape as the cross section S of the flexible traction element 6, but have a height slightly smaller than the thickness H of the traction element, so that when the first 41C and the second 41C′ engagement portions are superimposed and constrained together the flexible traction element 6 is compressed in the fixing through seat 44 blocking any possible translation of the crosspiece 40 with respect to the flexible traction element 6.

FIG. 8B is a perspective and partial view of the apparatus of FIG. 2, in which the support branch 4 is shown sectioned in the plane XZ. It can be seen that the first 41C and the second 41C′ engagement portions of the crosspiece 40 engage to the flexible traction element 6 at its intermediate section 8, thereby constraining the crosspiece 40 to the support branch 4. The crosspieces 40 are preferably made of aluminium or a stronger material than the spacer elements 30, in order to allow for a higher tightening force of the two half-crosspieces 41A, 41B which grip the feeding tubes 5 and the engagement portions 41C, 41C′ which grip the flexible traction elements 6.

Thanks to the increased rigidity of the crosspieces 40, high tightening torques can be applied to the connecting means engaged in the second and third fixing seats 42 and 43, without creating localised deformations on the crosspiece.

The thickness of the crosspiece 40, in the direction Z, is therefore mainly determined by the diameter of the tubes 5 and in general of the feeder lines to be guided and supported. The thickness of the spacer elements 30 is therefore substantially the same as that of the crosspieces 40. Said thickness must be greater than the diameter of the tubes so that when the layers are wound onto the drum, they rest on each other at the spacer element 30 of the support branches 4, while the feeding tubes 5 remain arranged in a position intermediate to the thickness of the spacer elements 30 so that they are not crushed by the outermost layers. At the same time, excessively high thicknesses of the spacer elements 30 and crosspieces 40 are avoided because increasing the thickness of the layers, i.e. of the support branches 4, increases the dimensions required for the winder necessary to accumulate said layers. An excessively sized winder may not be installable or may limit the maneuverability of the machine on which it is mounted.

In the preferred embodiment shown in FIG. 11, the through engagement seats 44 of the crosspieces are made at the ends of said crosspieces 40 so that each of said crosspieces can be connected to two support branches 4, being constrained to the traction element 6 passing through each branch. In FIG. 11, for the sake of clarity, a number of spacer elements 30 have been concealed (not shown) in order to allow the flexible traction elements 6 running inside the two support branches 4 to be seen. It is therefore to be understood that, even if not shown, the spacer elements occupy the entire available space between the two consecutive crosspieces 40.

In this way, the crosspieces 40 hold the two lateral support branches 4 of the support and guiding device 3 suitably spaced apart and preferably parallel, said crosspieces then being arranged perpendicular with respect to the longitudinal axis of the support branches 4.

The openable half-shell structure 41A, 41B, 41C′ enables the mounting of the crosspieces even when the flexible traction element 6 has already been coupled to all spacer elements 30, 39.

Preferably, the crosspieces 40 are fixed to the flexible traction elements 6 at regular intervals, i.e. with a predetermined number of spacer elements 30 between each crosspiece. In the embodiment in which each crosspiece 40 is connected to two or more support branches 4, said crosspiece 40 is prevented from rotating about the longitudinal axis of the branch by the fact that it has at least the two end ends constrained. Considering a section of support branch 4 included between two consecutive crosspieces, it can be understood that the two spacer elements 30 that are the closest to the crosspiece could undergo only very small rotations around the longitudinal axis of the chain allowed by the clearances present between the first seats 33 of the spacer elements 30 and the section of the flexible traction element 6. Continuing towards the centre of this section of the branch, each spacer element 30 may undergo very small rotations with respect to the previous spacer element, again due to the clearances. If all the small rotations were in the same direction, they would add up so that the spacer element that is in the middle of the branch section between two crosspieces would be the one that can undergo the maximum rotations. With the same clearances at the first seats 33, the maximum rotation amplitude of a spacer element 30 depends on the number of spacer elements 30 that are present between two consecutive crosspieces 40. It is therefore very easy to adjust this maximum rotation value by adjusting the distance between two consecutive crosspieces 40. This maximum rotation value of a single spacer element 30 is therefore completely independent of the total length of the support branch 4, which can be hundreds of metres. Advantageously, the crosspieces 40 are installed along the support branch 4 at a distance of no more than 4 to 5 metres from each other and this ensures that the possible rotations of the spacer elements 30 around the longitudinal axis of the flexible traction element 6 have almost no or substantially negligible amplitudes. In the particular embodiment in which the guiding and support apparatus 3 comprises only one support branch 4 the fixing seats 44 of the crosspieces 40 are advantageously made in an intermediate position, preferably medial with respect to the two ends of the crosspiece itself.

From the description given, the characteristics of the support and guiding apparatus for feeder lines covered by the present invention are clear, as are the advantages thereof.

In fact, the flexible traction element included in the support and guiding apparatus is lighter and less expensive than the steel ropes commonly used in the prior art, with the same tensile strength. If the flexible traction element is made up of fabric, the aforesaid advantages are even greater.

Furthermore, if the flexible traction element is made up of a synthetic material fabric, it is not affected by corrosion when immersed in the excavation filled with excavation fluids (bentonite).

Since the flexible traction element is continuous and has a substantially constant section, with the possible exception of the end sections, it is possible to fix the crosspieces in any position without having a precise pitch.

The non-axisymmetrical shape of the cross section of the flexible traction element and the corresponding shape of the first seat prevent the mutual rotation between the spacer element and the flexible traction element.

Finally, it is clear that the support and guiding apparatus for feeder lines thus conceived is susceptible to many modifications and variants, all falling within the same inventive concept; furthermore, all details can be replaced by equivalent technical elements. In practice, the materials used, as well as the dimensions thereof, can be of any type according to the technical requirements.

1. A support and guiding apparatus for feeder lines, comprising:
a feeding tube for a digging device;
a support branch; and
a plurality of transverse connecting elements or crosspieces adapted for guiding said feeding tube and connected to said support branch, wherein said support branch comprises:
a single flexible traction element, defining a longitudinal axis X when said flexible traction element is in an extended configuration, said flexible traction element having two opposite end sections and an intermediate section interposed between said end sections, said flexible traction element having, at least in the intermediate section, a cross section S in a plane YZ perpendicular with respect to said longitudinal axis X, said cross section S being substantially constant all along the length of said at least an intermediate section along the longitudinal axis (X), said cross section S having a width B extending in the direction of the axis Y and a thickness or height H extending in the direction of the axis Z where said width B is greater than said thickness or height H; and
a plurality of spacer elements coupled to said single flexible traction element, each one of said spacer elements having a first seat housing the flexible traction element and which is crossed by the flexible traction element, said first seat being shaped in such a way as to orient said flexible traction element along a lying plane XY, and to prevent rotation of the spacer element around the longitudinal axis X, each one of said spacer elements being arranged to allow rotation of the support branch around a rotation axis, said rotation axis being parallel with respect to said axis Y.

2. The support and guiding apparatus for feeder lines according to claim 1, wherein said first seat of each one of said spacer elements is made as a through cavity extending longitudinally between two opposite faces of said spacer element and defining on said opposite faces two openings having an elongated shape in a direction parallel with respect to the axis Y.

3. The support and guiding apparatus for feeder lines according to claim 1, wherein said spacer elements are slidably coupled to the flexible traction element.

4. The support and guiding apparatus for feeder lines according to claim 1, wherein said spacer elements are coupled in an axially fixed way to the flexible traction element.

5. The support and guiding apparatus for feeder lines according to claim 1, wherein the opposite faces where the first seat faces have an outside convex shape.

6. The support and guiding apparatus for feeder lines according to claim 1, wherein each one of said spacer elements comprises a first half-shell and a second half-shell placed one above the other and constrained between them.

7. The support and guiding apparatus for feeder lines according to claim 1, wherein each one of said spacer elements is monolithic or made from a single shell.

8. The support and guiding apparatus for feeder lines according to claim 1, wherein said flexible traction element is made up of fabric.

9. The support and guiding apparatus for feeder lines according to claim 8, wherein said fabric is constituted of synthetic or plastic material yarns.

10. The support and guiding apparatus for feeder lines according to claim 8, wherein said fabric is at least partially or entirely made of metallic yarns.

11. The support and guiding apparatus for feeder lines according to claim 1, wherein the width B of the cross section S is at least 3 times greater than the height or thickness H of the cross section S.

12. The support and guiding apparatus for feeder lines according to claim 1, wherein the width B of the cross section S is at least 4 times greater than the height or thickness H of the cross section S.

13. The support and guide apparatus for supply lines according to claim 1, wherein each one of said cross members comprises:
at least a through guide seat adapted to guide said at least one feeding tube;
at least one through engagement seat, suitable to fix the crosspieces to the flexible traction element.
